(19) United States
(12) Patent Application Publication
(10) Pub. No.: US 2005/0231589 A1
(43) Pub. Date: Oct. 20, 2005

(54) Panoramic photographing monitoring and tracking system and method

(76) Inventor: Yu-Lin Chiang, Kaohsiung City (TW)

Correspondence Address: BIRCH STEWART KOLASCH & BIRCH, PO BOX 747, FALLS CHURCH, VA, 22040-0747, US

(21) Appl. No.: 11/085,168

(22) Filed: Mar. 22, 2005

(30) Foreign Application Priority Data
Mar. 23, 2004 (TW) 93107805

(51) Int. Cl. H04N 7/18

(52) U.S. Cl. 348/36; 348/143

(57) ABSTRACT

A panoramic photographing monitoring and tracking system and method is disclosed. The system comprises a panoramic camera used to acquire a 360-degree spatial image and output an expanded planar image of the acquired spatial image, a speed dome camera used to track and photograph an object image, a coordinate interpreting module coupled to the panoramic camera and the speed dome camera to interpret coordinates of the expanded planar image and the object image, an initialization collation module used to collate the coordinates of the expanded planar image and the object image and a display unit having an expanded planar image area and an object image area used to display the object image and a relative position between the object image and the planar expanded image corresponding thereto.

### BACKGROUND OF THE INVENTION

1. Field of Invention

The present invention relates to photographing system and method and particularly to panoramic photographing monitoring and tracking system and method.

2. Related Art

Monitoring systems have long been used as facility for safety guard. In prior monitoring systems, several video cameras are generally used in cooperation to achieve the desired safety guard function as shown in FIG. 1. In such monitoring system 100, a first monitor 110, a second monitor 120 to an N-th monitor 130 are comprised and connected through the monitoring system 100. In this manner, a moving object 140 may be monitored by manipulating or controlling the monitors 110,120,130 in a proper manner. Each of the monitors 110,120,130 is connected in this configuration for not only transmitting acquired images to the monitoring system 100 but also receiving commands for control of the monitors 110,120,130 from the monitoring system 100.

In the above monitoring system, each monitor may be rotated, i.e. change its monitoring focus. As such, each monitor may have its changeable monitoring range. To achieve full range monitoring, a plurality of video cameras are generally necessary and operated in turn so that a good geographical coverage may be obtained. Further, since picture frames are not continuously provided by the monitors, a disadvantage arises that an operator has to identify the monitor which provides some specific picture frames. The multi-monitors scheme also has the following problems: (1) A resource waste unavoidably occurs if geographical coverage provided by two monitors is overlapped, (2) The monitoring may have something to be missed out if the geographical coverage is not properly arranged through configuration of the monitors and (3) Installation, maintenance and equipment of the monitoring system are pricy.

Speed dome camera which provides an automatic tracking function is another monitoring system priorly used. To achieve the object monitoring purpose, such video cameras have to cooperate with a fixed camera in operation. However, the speed dome camera may only catch images in front thereof and the fixed video camera may only catch image within its specific range. It is impossible to obtain images beyond the ranges provided by the speed dome camera and the fixed video camera with respect to this kind of monitoring system.

If the specific monitoring range provided by the speed dome camera may be broadened to a panoramic range, full geographical coverage may then be achieved. In this regard, there is a need created to provide a simple automatic monitoring system which may provide a good geographical coverage.

### SUMMARY OF THE INVENTION

The present invention discloses a panoramic photographing monitoring and tracking system, comprising a panoramic camera, a speed dome camera, a coordinate interpreting module, an initialization collation module and a display module.

The present invention also discloses a panoramic photographing monitoring and tracking method, comprising the steps of: acquiring a 360-degree spatial image and outputting an expanded planar image of the acquired spatial image, monitoring and tracking an object image by a speed dome camera, interpreting coordinates of the expanded planar image and the object image, collating the coordinates of the expanded planar image and the object image upon each monitoring and tracking operation being initialized and outputting at all time the object image and a monitoring and tracking signal as to a relative position between the object image and the planar expanded image corresponding thereto.

Therefore, the problem encountered in the prior art that panoramic monitoring and tracking may not be achieved and thus a poor geographical coverage is caused. Further, a user of the inventive system may not only efficiently aim and track an object without any error but also easily catch or spotlight images of any object presented in the panoramic images in time by means of the speed dome camera through a mouse where the images shown may be scaled up or down as desired. Meanwhile, any event occurred beyond the visible range of the speed dome camera may be readily seen in the panoramic images and thus monitored and tracked.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram of a prior moving object monitoring system;

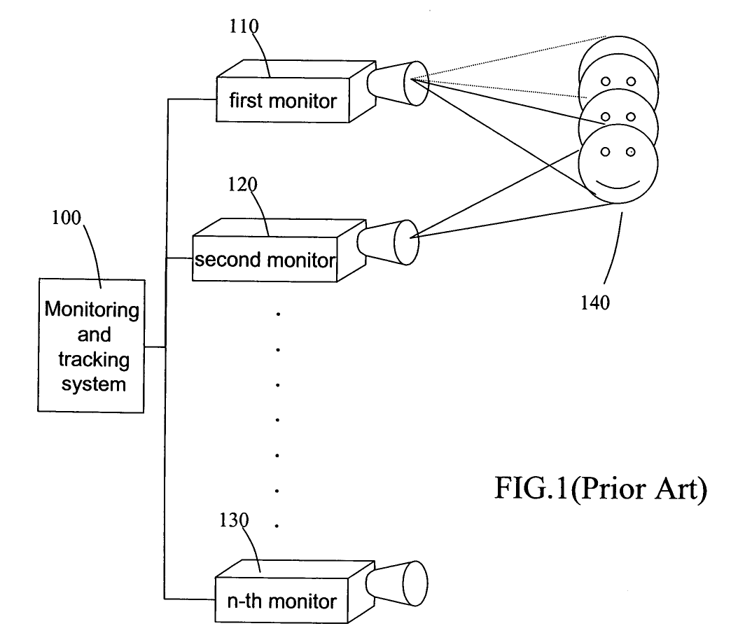

FIG. 2 is a schematic diagram of a panoramic photographing monitoring and tracking system according to the present invention;

FIG. 3 is a schematic diagram of a display module of the panoramic photographing monitoring and tracking system according to the present invention; and

FIG. 4 is a flowchart illustrating the panoramic photographing monitoring and tracking method according to the present invention.

### DETAILED DESCRIPTION OF THE INVENTION

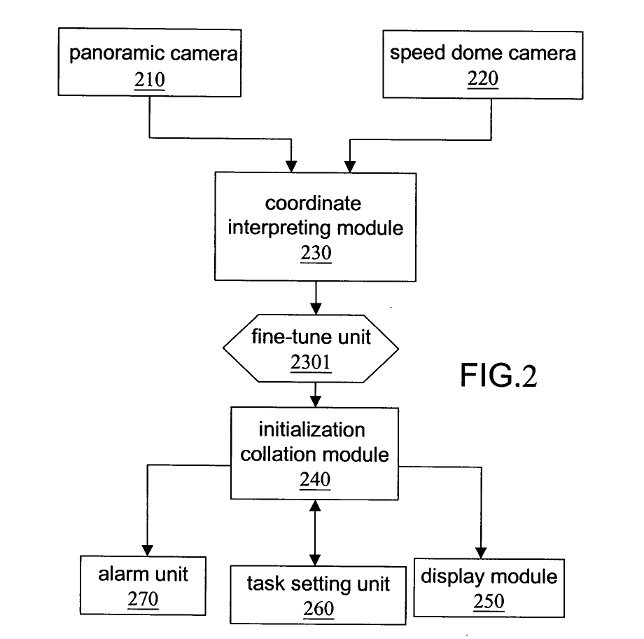

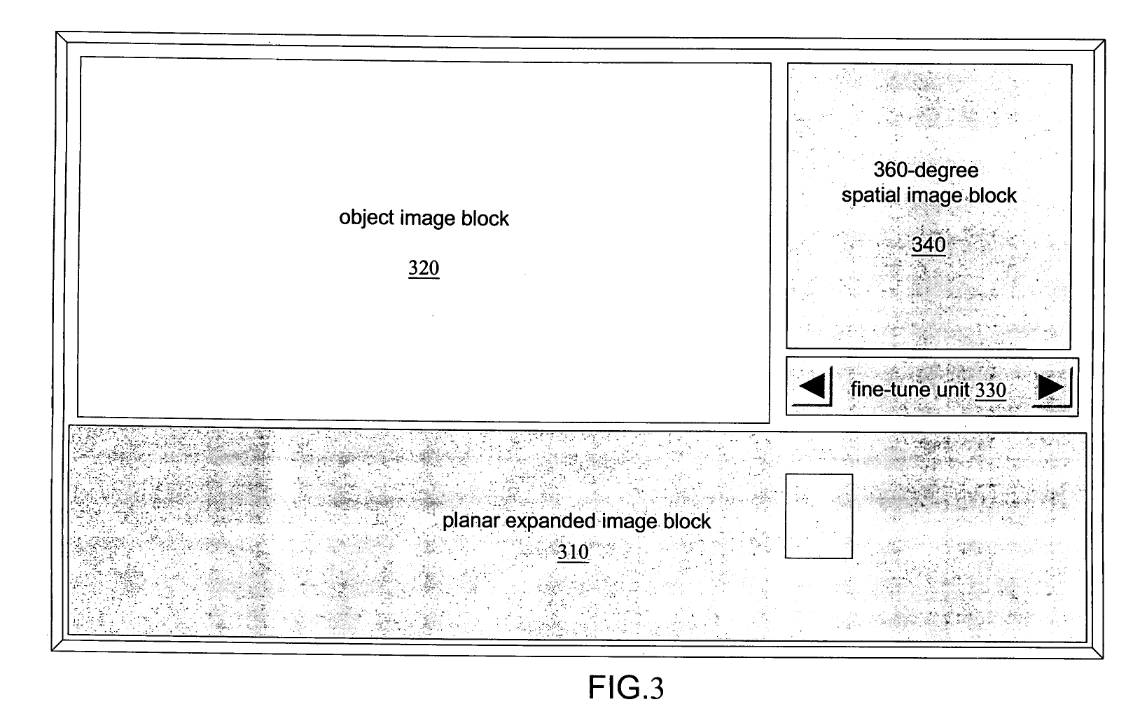

Referring to FIG. 2, a panoramic photographing monitoring and tracking system according to the present invention is schematically shown therein. The system comprises a panoramic camera 210, a speed dome camera 220, a coordinate interpreting module 230, an initialization collation module 240 and a display module 250. Further, a display module is provided in cooperation with the panoramic photographing monitoring and tracking system and shown in layout in FIG. 3.

In the system, the panoramic camera 210 is used to acquire a 360-degree spatial image and then output an expanded planar image in responsive to the 360-degree spatial image. The speed dome camera 220 is used to track and photograph an object image. The coordinate interpreting module 230 is coupled to the panoramic camera 210 and the speed dome camera 220, respectively, to interpret coordinates of the expanded planar image and the object image. The initialization collation module 240 is used to collate the coordinates of the expanded planar image and the object image. The system further comprises a display module 250 on which an expanded planar image block 310 and an object image block 320 are lain out.

In the panoramic camera 210 and the speed dome camera 220, an image capture card is provided to acquire inputted image. Then, the spatial image and the object image are outputted to the coordinate interpreting module 230.

The expanded planar image is computed and obtained by a space dimension conversion program library, where a three dimensional image is conversed into a two dimensional image. The initialization collation module 240 is used to make an initialized setting as to a relative position between the object image and the planar expanded image corresponding thereto through a fine-tune unit 2301. Preferably, a mouse is used for setting the initialization collation process. After the setting is finished, the object image may be precisely monitored and tracked.

In a real monitoring and tracking process, the object image obtained from a moving object is enclosed by a frame in the display unit. When a plurality of moving objects are presented, each of the object images corresponding thereto is enclosed by a frame, each frame being different from the others in size. As such, a user may optionally set a priority on the object images based on the different object images obtained in the monitoring and tracking process.

Further, the system also provides a task setting unit 260 for a specific space and time monitoring and tracking task, particularly for an independent monitoring and tracking task for a specific space within a specific time period, such as for a safe. As long as a relative position between the system and the safe, a self-defined monitoring and tracking function may be achieved, in which the user may set a desired time period for object monitoring and tracking.

The system may be further coupled to an alarm unit 270 through which a force signal and an exception signal may be inputted and an alarm signal may be outputted in responsive to the force and exceptional signals. Optionally, the alarm signal may be played out through a loudspeaker.

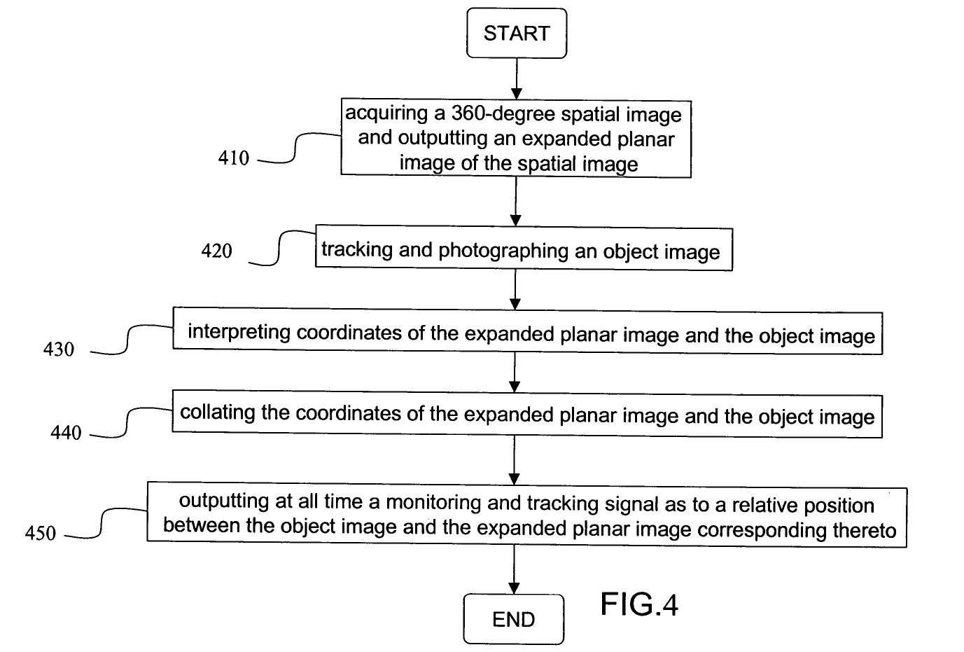

FIG. 4 shows a flowchart illustrating the panoramic photographing monitoring and tracking method of the invention. As shown, the method comprises the following steps. A 360-degree spatial image is first acquired and an expanded planar image conversed from the spatial image is outputted (Step 410). Next, monitoring and photographing the object image by means of a speed dome camera (Step 420). Then, coordinates of the expanded planar image and the object image are interpreted (Step 430). For each object monitoring and tracking process, the coordinates of the expanded planar image and the object image are required to be respectively collated (Step 440). Finally, a monitoring and tracking signal as to a relative position between the object image and the planar expanded image corresponding thereto is outputted at all time(Step 450), wherein the monitoring and tracking signal may be outputted to a display device or a storage medium for recordation.

The system of the invention has a simple architecture and thus possibility of failed equipment or man-made damage may be reduced. Further, since the panoramic camera 210 is provided in the system, a full range picture frame may be presented like an electronic map. The user may direct the speed dome camera to spotlight any region at any time by selecting a corresponding portion on the display unit. With such intuitive operation manner, the user may respond to any event in time and thus may avoid any loss in safety guard.

Since the panoramic camera 210 is used, the panoramic camera 210 has a visible range equivalent to a moving range of the speed dome camera 220. Hence, the relative coordinate of the speed dome camera 220 with respect to the panoramic camera 210 may be obtained by interpreting the coordinate of the panoramic camera 210. For the user, the only required operation is to set a relative angle between the two cameras 210,220 by means a mouse when the system is first time used.

The panoramic photographing monitoring and tracking system and method may be applicable to the following situations. (1) Monitoring and tracking of organizations, banks, public places, crossroads and communities for safety guard. (2) Monitoring and tracking of offices and factory buildings. (3) Monitoring and tracking of bus stations, buses, train carriages, ships and the like. (4) Tanks, submarines and other military transportation means requiring real time information as to the ambient environment. (5) Distant educations, surgical operations and video conferences where facial expressions and limbs actions of participants are required to be observed. (6) Observation stations in mountains, oil wells, ecological observation areas and other areas where are not accessible or dangerous to humans.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

1. A panoramic photographing monitoring and tracking system, comprising:
a panoramic camera used to acquiring a 360-degree spatial image and output an expanded planar of the spatial image;
a speed dome camera configured to track and photograph an object image;
a coordinate interpreting module coupled to the panoramic camera and the speed dome camera and interpreting coordinates of the expanded planar image and the object image, respectively;
an initialization collation module collating the coordinates of the expanded planar image and the object image, respectively; and
a display module comprising an expanded planar image block and an object image block and displaying a relative position between the object image and the expanded planar image corresponding thereto.

2. The system of claim 1, further comprising an image capture card used to capture and output the spatial image and the object image.

3. The system of claim 1, wherein the expanded planar image is obtained through a computation by an image dimension conversion program library in which a tree-dimensional image is conversed into a two-dimensional image.

4. The system of claim 1, wherein the initialization collation unit sets the relative position by means of a fine-tune unit.

5. The system of claim 1, wherein the object image is enclosed by a frame based on a moving object.

6. The system of claim 1, wherein the object image is set with a priority for facilitated monitoring and tracking.

7. The system of claim 1, further comprising a task setting unit through which a user sets a specific space and time monitoring.

8. The system of claim 1, further comprising an alarm unit through which a force signal and an exception signals are inputted and an alarm signal is outputted.

9. A panoramic photographing monitoring and tracking method, comprising the steps of:
acquiring a 360-degree spatial image and outputting an expanded planar image of the spatial image;
tracking and photographing an object image;
interpreting coordinates of the expanded planar image and the object image;
collating the coordinates of the expanded planar image and the object image; and
outputting at all time a monitoring and tracking signal as to a relative position between the object image and the expanded planar image corresponding thereto.

10. The method of claim 9, wherein the expanded planar image is obtained through a computation by an image dimension conversion program library in which a tree-dimensional image is conversed into a two-dimensional image.

11. The method of claim 9, wherein the object image is enclosed by a frame based on a moving object.

12. The method of claim 9, wherein the object image is set with a priority for facilitated monitoring and tracking.

13. The method of claim 9, further comprising a step of setting a specific space and time for object monitoring.

14. The system of claim 9, further comprising an alarm unit through which a force signal and an exception signals are inputted and an alarm signal is outputted.

15. The method of claim 14, wherein the alarm signal is outputted to an external loudspeaker.

16. The method of claim 9, wherein the monitoring and tracking signal is outputted to a display device or a storage medium for recordation.
